(19) United States
(12) Patent Application Publication
(10) Pub. No.: US 2024/0256287 A1
(43) Pub. Date: Aug. 1, 2024

(54) TRUSTED PLATFORM MODULE ATTESTATION FOR SOFT REBOOTS

(71) Applicant: VMware LLC, Palo Alto, CA (US)

(72) Inventors: Tim Schlueter, Seattle, WA (US); Jesse Pool, Ottawa (CA); Harsh Dinesh Grover, Sunnyvale, CA (US); Ashish Kaila, Cupertino, CA (US); Tobias Stumpf, Dresden (DE); Stanley Zhang, Palo Alto, CA (US)

(73) Assignee: VMware, Inc., Palo Alto, CA (US)

(21) Appl. No.: 18/102,206

(22) Filed: Jan. 27, 2023

(51) Int. Cl. G06F 9/4401

(52) U.S. Cl. CPC G06F 9/4408

(57) ABSTRACT

TPM attestation for soft reboots is described herein. One embodiment includes instructions to receive a request to perform a soft reboot of a computing device executing an existing OS instance and having a TPM, and perform a soft reboot process on the computing device responsive to receiving the request. The soft reboot process can include loading a new kernel and boot modules associated with a new OS instance into a memory of the computing device, measuring the boot modules into PCRs of the TPM, generating entries in an event log of the TPM corresponding to the boot modules and the new kernel, exporting the event log and a metadata file associated with the existing OS instance to storage, importing the event log from storage to the new kernel, copying the metadata file from storage to a server, and storing a new metadata file created from manifests of the new OS instance at the server.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

A software defined data center (SDDC) can include objects, which may be referred to as virtual objects. Virtual objects, such as virtual computing instances (VCIs), for instance, have been introduced to lower data center capital investment in facilities and operational expenses and reduce energy consumption. A VCI is a software implementation of a computer that executes application software analogously to a physical computer. Virtual objects have the advantage of not being bound to physical resources, which allows virtual objects to be moved around and scaled to meet changing demands of an enterprise without affecting the use of the enterprise's applications. In a software defined data center, storage resources may be allocated to virtual objects in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for TPM attestation for soft reboots according to one or more embodiments of the present disclosure.

FIG. 2 is a block diagram of a computer system in which one or more embodiments of the present invention may be implemented.

FIG. 3 is a flow chart associated with TPM attestation for soft reboots according to one or more embodiments of the present disclosure.

FIG. 4 is a diagram of a system for TPM attestation for soft reboots according to one or more embodiments of the present disclosure.

FIG. 5 is a diagram of a machine for TPM attestation for soft reboots according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

Where the present disclosure refers to VCIs, the examples given could be any type of virtual object, including data compute node, including physical hosts, VCIs, non-VCI containers, virtual disks, and hypervisor kernel network interface modules. Embodiments of the present disclosure can include combinations of different types of virtual objects (which may simply be referred to herein as “objects”). As used herein, a container encapsulates an application in a form that's portable and easy to deploy. Containers can run without changes on any compatible system— in any private cloud or public cloud—and they consume resources efficiently, enabling high density and resource utilization. Although containers can be used with almost any application, they may be frequently associated with microservices, in which multiple containers run separate application components or services. The containers that make up microservices are typically coordinated and managed using a container orchestration platform.

A hypervisor can be rebooted according to a set of executable instructions. During a normal boot/reboot, trusted platform modules (TPMs) can be used by an external system in attesting the software which is run on a machine and validating it against known good copies of the software. For example, a TPM can attest the Basic Input/Output System (BIOS), Peripheral Component Interconnect (PCI) option read-only memories (ROMs) (e.g., from network cards), boot loader, and/or the kernel, along with their respective configurations. Each measurement is stored as an event in a Trusted Computing Group (TCG) format, and the ordered sequence of all these events may be referred to as an event log. An event includes information about the measured software, such as its name, data, and hash. Expected values for this installed software can be stored in a cryptographically signed file (referred to herein as a “metadata file”) on the host. TPM 2.0 devices contain 24 different Platform Configuration Registers (PCRs), which contain a running SHA-256 hash of each previous measurement. An attester uses the event log, the metadata file, and the hashes in the PCRs to validate the various software.

In some instances, a hypervisor may be able to undergo a “soft” reboot. VMware Quick Boot is an example of a soft reboot methodology (see, e.g., U.S. Pat. Nos. 10,586,048 and 8,429,390, each of which is incorporated by reference in its entirety). Unlike a regular host reboot operation (warm or cold), Quick Boot does not involve going through the actual hardware reboot process. When a Quick Boot is initiated, a hypervisor (e.g., ESXi) restarts in a way similar to a normal reboot operation but the hardware does not go through the normal process of reboot operations such as POST, firmware load, re-initialization of hardware resources, reload ACPI/SMBIOS tables etc. In short, Quick Boot allows rebooting of ESXi systems without going through the BIOS routines. If the hardware topology of the machine has not changed and the binaries to execute are already present, the system can be restarted instantly without performing a normal reboot. However, in previous approaches, if a host has a TPM, it may not be able to be Quick Booted. It is noted that while the present disclosure refers to the example of Quick Boot, embodiments herein are not so limited. The present disclosure applies to other methodologies of soft rebooting in addition to Quick Boot that allow rebooting without performing BIOS routines. Additionally, it is noted that while the specific example of a hypervisor is discussed herein, embodiments of the present disclosure are not so limited. For instance, VCIs can be soft rebooted in accordance with embodiments herein.

During a soft reboot, a TPM device is not reinitialized. As a result, it is problematic to remotely attest the software being run after a soft reboot. To solve this, the present disclosure allows the existing (e.g., old) kernel to make measurements about some of the software that will be run as part of the new kernel. In addition, embodiments herein provide a way for the existing kernel to persist the metadata file for the new kernel. Once the new kernel has this data, attesters can use it to validate the software. Stated differently, embodiments herein can pass the event log and the metadata file to the new kernel, and measure any new software that will be run as part of the new kernel.

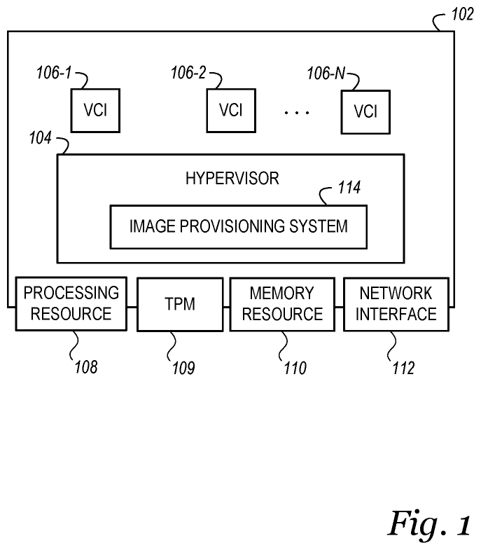

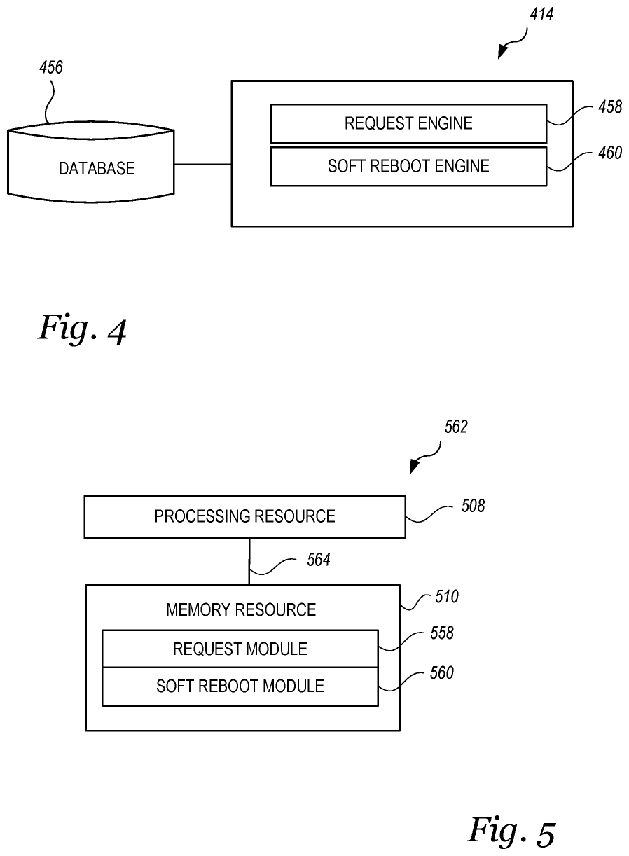

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 414 in FIG. 4. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for TPM attestation for soft reboots according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104. The hypervisor can include a soft reboot system 114. Stated differently, in some embodiments, the soft reboot system 114 can be built and/or executed as part of the hypervisor 104. An example of the soft reboot system is illustrated and described in more detail below. The hypervisor 104 can execute a number of virtual computing instances 106-1, 106-2, . . . , 106-N(referred to generally herein as “VCIs 106”). The VCIs can be provisioned with processing resources 108, TPM 109, and/or memory resources 110 and can communicate via the network interface 112. Soft rebooting embodiments herein can change the state of the processing resources 108, the TPM 109, the memory resources 110, and/or the network interface 112. The processing resources 108, the TPM 109, and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106.

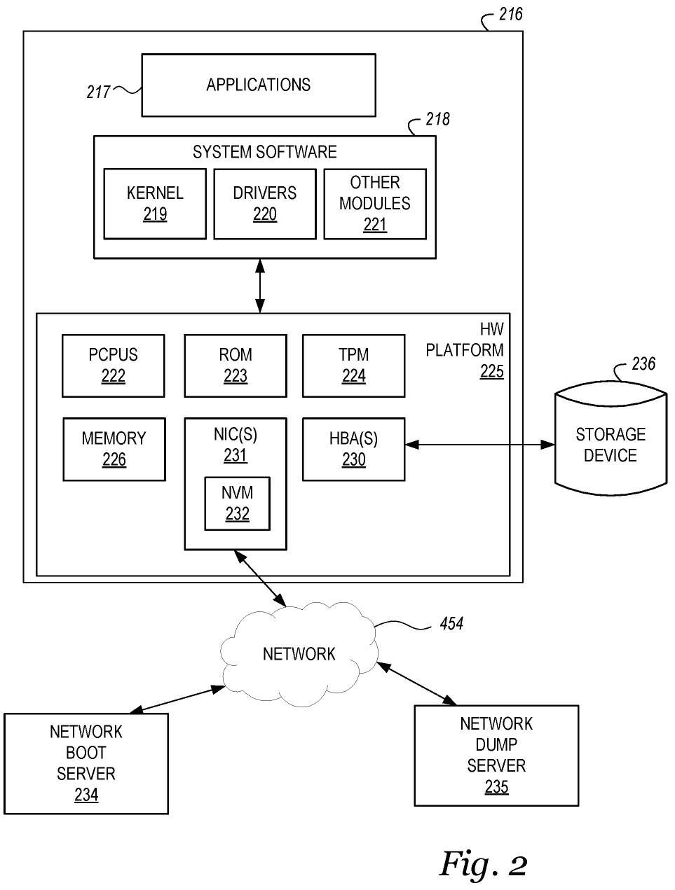

FIG. 2 is a block diagram of a computer system 216 in which one or more embodiments of the present invention may be implemented. The computer system 216 includes one or more applications 217 that are running on top of the system software 218. The system software 218 includes a kernel 219, drivers 220 and other modules 221 that manage hardware resources provided by a hardware platform 225. In one embodiment, the system software 218 is an operating system (OS), such as operating systems that are commercially available. In another embodiment, system software 218 is a hypervisor that supports virtual machine applications running thereon. The hardware platform 225 includes one or more physical central processing units (pCPUs) 222, system memory 226 (e.g., dynamic random access memory (DRAM)), read-only-memory (ROM) 223, a TPM 224, one or more network interface cards (NICs) 231 that connect the computer system 216 to a network 233, and one or more host bus adapters (HBAs) 230 that connect to storage device(s) 236, which may be a local storage device or provided on a storage area network. In the descriptions that follow, a pCPU denotes either a processor core, or a logical processor of a multi-threaded physical processor or processor core if multi-threading is enabled. Each NIC 231 includes a non-volatile memory section 232 that stores the firmware for the device. In the embodiments described herein, the firmware for NIC 231 includes UNDI (Universal Network Device Interface) application programming interfaces (APIs). UNDI APIs provide a device-agnostic way to gain network access without the use of any drivers, and are used for network access during a network boot process prior to loading of the NIC drivers. According to one or more embodiments of the present invention, UNDI APIs are preserved in the system memory 226 post-boot and are used for network access during a network core dump process.

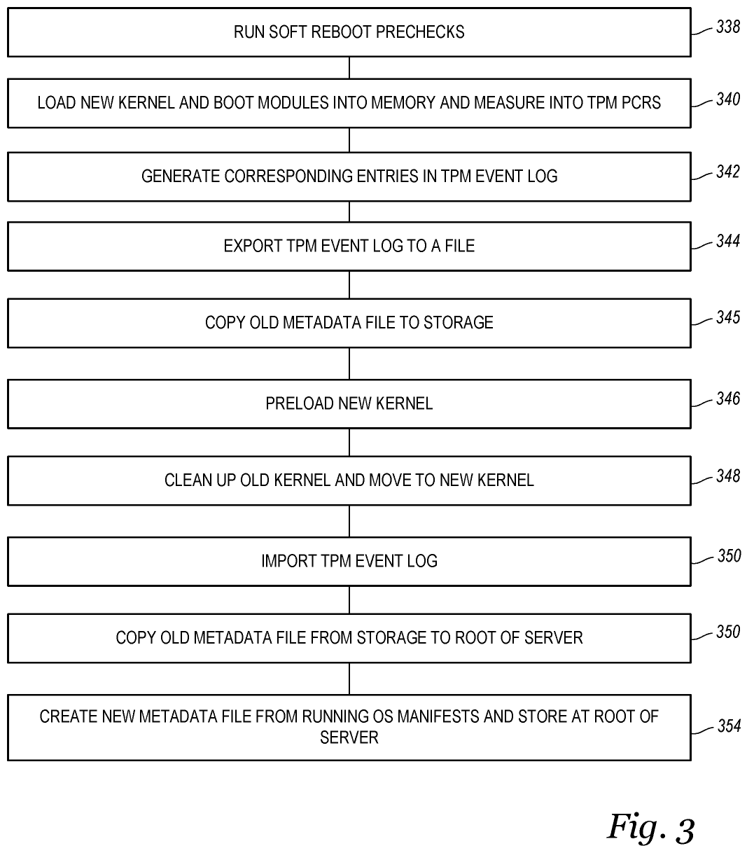

FIG. 3 is a flow chart associated with TPM attestation for soft reboots according to one or more embodiments of the present disclosure. As previously discussed, embodiments herein can pass the event log and the metadata file to the new kernel. For example, the TPM event log can be exported by the existing kernel during the shutdown process and can be stored in a TCG format in storage. In some embodiments, the storage is persistent storage, though embodiments herein are not so limited. The event log can be imported into the memory by the new kernel. The metadata file can be exported by the old kernel during the shutdown process and stored in storage. During the import process, the new kernel can move the metadata file to the root folder of a server so that it can be accessed by remote attesters. This server can be referred to as “an attestation server,” a “remote server,” and/or a “remote attestation server,” for instance.

Embodiments herein can measure any new software that will be run as part of the new kernel. For instance, before exporting the event log, the old kernel can perform measurements on the content of a number of items and add these measurements to the event log. These items can include the new kernel, the version of the new kernel, boot modules, the new kernel's signer certificate, the new kernel's command line, and the new kernel's boot options. A boot module, as referred to herein, is executable software and/or file(s) used as part of a boot process. Generally, boot modules can include binaries, tardisks, vSphere installation bundles (VIBs), root filesystems, initial random access memory (RAM) disks (initrds), initramfs, and/or installation modules, for instance.

An OS usually supports one or more container formats to install software. In the example of Linux, this may be Debian Software Package (deb) format and/or RPM Package Manager (RPM) format; in the example of ESXi, this may be VIB. These containers can include a set of metadata (referred to herein as a “metadata file”) that describe the content therein. These containers can include security hashes to check the integrity of the content and ensure that the container was provided by a trusted authority (e.g., a trusted entity such as VMware). In some operating systems (e.g., Linux or Windows), these containers can include files stored on a file system. In other operating systems, these containers can include other containers, such as a tardisk. A tardisk, as referred to herein, is an abstract format for a file system. A tardisk can be mounted like a physical partition and its content can appear in the file system hierarchy. A mounted tardisk is a virtual file system in memory and is volatile. Accordingly, during a reboot, the tardisk is reloaded.

At 338, soft reboot prechecks can be executed to ensure the system is compatible. At 340, the new kernel and boot modules can be loaded into memory, and can be measured into the TPM PCRs. Corresponding entries can be generated in the TPM event log at 342. According to TPM guidelines, measurements are made before the new kernel is run (e.g., while the existing kernel is still running). At 344 the TPM event log is exported to a file (e.g., on persistent storage). At 345, the old (e.g., existing) metadata file is copied from the root of the server (e.g., the old server) to storage. In some embodiments, the storage is persistent storage. In some embodiments, the storage is nonpersistent storage (e.g., volatile memory). At 346, the new kernel is preloaded, and at 348, the soft reboot process cleans up the old kernel and jumps to the new kernel. At 350, the import process begins with the TPM event log being imported (e.g., from persistent storage). The old metadata file is copied from storage to the root folder of the new server (e.g., for remote attestation) at 352. A new metadata file is created from the running system's manifests and stored at the root folder of the new server at 354.

Each OS typically maintains a database about software installed thereon. This database can include the signatures required for attestation. For remote attestation, the software and configuration of a host is validated. In some embodiments, a remote attestor uses its own database with signature information. In some embodiments, a remote attestation tool receives the database from the attested host. In either case, the remote attestor can receive the event log and validate that only a trusted configuration is executed (e.g., that the host is in a trusted configuration). The host being attested can reply with the event log and a PCR quote (e.g., a cryptographically signed copy of the current PCR value).

During bootstrapping of an OS, the host configuration (e.g., installed software, settings, etc.) is measured. For example, a TPM can attest the Basic Input/Output System (BIOS), Peripheral Component Interconnect (PCI) option read-only memories (ROMs) (e.g., from network cards), boot loader, and/or the kernel, along with their respective configurations. A remote attestation tool can validate this process before a new host is added to a cluster or before VCIs are executed. In some embodiments, this validation is performed once. In some embodiments, this validation is performed a plurality of times (e.g., regularly). Further, in some cases, the OS may only measure the booted software while in other cases the OS may measure additional executed binar(ies) or software that gets installed after bootup. What information is measured depends on the remote attestation protocol. A TPM chip has a plurality of registers. One or more registers can be used for the initial configuration, and one or more additional registers can be used for later host changes. Embodiments of the present disclosure handle remote attestation in a way that does not negatively affect existing remote attestation tools while providing new attestation tools—that may provide stronger security—the ability to measure the soft reboot.

Some approaches to remote attestation include measuring the initial boot and ignoring any software reboots. This approach may be of some use with existing remote attestation tools but suffers from a shortcoming in that a remote attestator may not be able to detect if a soft reboot was performed. If, for instance, a soft rebooted version has a security issue, that issue may go ignored in such approaches.

Other approaches to remote attestation include measuring the initial boot and placing an additional message for the soft reboot. Existing remote attestation tools can detect the soft reboot from the message and provide a notification that the host is in an unexpected state. Still other approaches to remote attestation include measuring the initial boot and any soft reboot into the same registers. Existing remote attestation tools can detect that the host runs different software than expected. Further, existing remote attestation tools can continue the validation and verify the soft reboot. These types of approach may require changes in remote attestation tooling.

Remote attestation in accordance with embodiments of the present disclosure can include measuring the initial boot into a first set of registers. Then, a soft reboot can be measured into a second set of registers. Existing remote attestation tools, which only validate the booted system, will flag the host as trusted. If the host is trusted, the host only accepts only trusted software, and a soft reboot is only performed by trusted software that can be validated by the host, then the security of the cluster can be maintained, and soft reboots can be performed on a TPM-enabled host. Further, a remote attestation tool seeking to execute software installed on the host can validate the additional register(s). Hence, the whole chain of initial boot and one or more soft reboots can be validated.

In some instances, it is possible that some reboots might fail and some measurements would have already been taken for various events into the TPM. Those events cannot be removed from the event log because PCRs can only be extended so it may become difficult to track which kernel version/modules are being run currently on the system. To make tracking easier, embodiments herein introduce a new event, referred to as a “Boot Complete event.” This event can be measured by the new kernel into the TPM and can be used to determine if the soft reboot was successful. Stated differently, in the absence of this event, it can be assumed that the soft reboot failed. Attesters can also use this event to track the currently running kernel/modules. It is noted that the measurement of the failed soft reboot may be carried out because it is possible that some code from a pre-loaded OS may have been executed. Accordingly, not tracking this event may cause a security risk.

FIG. 4 is a diagram of a system for TPM attestation for soft reboots according to one or more embodiments of the present disclosure. The system 414 can include a database 456 and/or a number of engines, for example request engine 458 and/or soft reboot engine 460, and can be in communication with the database 456 via a communication link. The system 414 can include additional or fewer engines than illustrated to perform the various functions described herein. The system can represent program instructions and/or hardware of a machine (e.g., machine 562 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 458 can include a combination of hardware and program instructions that is configured to receive a request to perform a soft reboot of a computing device executing an existing OS instance and having a TPM. In some embodiments, the soft reboot engine 460 can include a combination of hardware and program instructions that is configured to perform a soft reboot process on the computing device responsive to receiving the request. In some embodiments, the soft reboot process can include loading a new kernel and boot modules associated with a new OS instance into a memory of the computing device. In some embodiments, the soft reboot process can include measuring the boot modules into platform configuration registers (PCRs) of the TPM. In some embodiments, the soft reboot process can include generating entries in an event log of the TPM corresponding to the boot modules and the new kernel. In some embodiments, the soft reboot process can include exporting the event log and a metadata file associated with the existing OS instance to storage. In some embodiments, the soft reboot process can include importing the event log from storage to the new kernel. In some embodiments, the soft reboot process can include copying the metadata file from storage to a server. In some embodiments, the soft reboot process can include storing a new metadata file created from manifests of the new OS instance at the server.

FIG. 5 is a diagram of a machine for TPM attestation for soft reboots according to one or more embodiments of the present disclosure. The machine 562 can utilize software, hardware, firmware, and/or logic to perform a number of functions. The machine 562 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 562 (e.g., the machine 562 can include internal memory resources and have access to external memory resources). In some embodiments, the machine 562 can be a virtual computing instance (VCI). The program instructions (e.g., machine-readable instructions (MRI)) can include instructions stored on the MRM to implement a particular function (e.g., an action such as preloading a new kernel, as described herein). The set of MRI can be executable by one or more of the processing resources 508. The memory resources 510 can be coupled to the machine 562 in a wired and/or wireless manner. For example, the memory resources 510 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 508 can be coupled to the memory resources 510 via a communication path 564. The communication path 564 can be local or remote to the machine 562. Examples of a local communication path 564 can include an electronic bus internal to a machine, where the memory resources 510 are in communication with the processing resources 508 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 564 can be such that the memory resources 510 are remote from the processing resources 508, such as in a network connection between the memory resources 510 and the processing resources 508. That is, the communication path 564 can be a network connection. Examples of such a network connection can include a local area network (LAN), wide area network (WAN), personal area network (PAN), and the Internet, among others.

As shown in FIG. 5, the MRI stored in the memory resources 510 can be segmented into a number of modules 558, 560 that when executed by the processing resources 508 can perform a number of functions. As used herein a module includes a set of instructions included to perform a particular task or action. The number of modules 558, 560 can be sub-modules of other modules. For example, the soft reboot module 660 can be a sub-module of the request module 558 and/or can be contained within a single module. Furthermore, the number of modules 558, 560 can comprise individual modules separate and distinct from one another. Examples are not limited to the specific modules 558, 560 illustrated in FIG. 5.

Each of the number of modules 558, 560 can include program instructions and/or a combination of hardware and program instructions that, when executed by a processing resource 508, can function as a corresponding engine as described with respect to FIG. 4. For example, the request module 558 can include program instructions and/or a combination of hardware and program instructions that, when executed by a processing resource 508, can function as the request engine 458, though embodiments of the present disclosure are not so limited.

The machine 562 can include a request module 558, which can include instructions to receive a request to perform a soft reboot of a computing device executing an existing operating system (OS) instance and having a trusted platform module (TPM). The machine 562 can include a soft reboot module 560, which can include instructions to perform a soft reboot process on the computing device responsive to receiving the request, the soft reboot process comprising loading a new kernel and boot modules associated with a new OS instance into a memory of the computing device, measuring the boot modules into platform configuration registers (PCRs) of the TPM, generating entries in an event log of the TPM corresponding to the boot modules and the new kernel, exporting the event log and a metadata file associated with the existing OS instance to storage, importing the event log from storage to the new kernel, copying the metadata file from storage to a server, and storing a new metadata file created from manifests of the new OS instance at the server.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
receive a request to perform a soft reboot of a computing device executing an existing operating system (OS) instance and having a trusted platform module (TPM); and
perform a soft reboot process on the computing device responsive to receiving the request, the soft reboot process comprising:
loading a new kernel and boot modules associated with a new OS instance into a memory of the computing device;
measuring the boot modules into platform configuration registers (PCRs) of the TPM;
generating entries in an event log of the TPM corresponding to the boot modules and the new kernel;
exporting the event log and a metadata file associated with the existing OS instance to storage;
importing the event log from storage to the new kernel;
copying the metadata file from storage to a server; and
storing a new metadata file created from manifests of the new OS instance at the server.

2. The medium of claim 1, including instructions not to perform any Basic Input/Output System (BIOS) routines as a portion of the soft reboot.

3. The medium of claim 1, including instructions to measure, into the PCRs of the TPM:
the new kernel;
a version of the new kernel;
a signer certificate associated with the new kernel;
a command line associated with the new kernel; and
boot options associated with the new kernel.

4. The medium of claim 1, including instructions to export the event log to a file on persistent storage

5. The medium of claim 1, including instructions to copy the metadata file from storage to a root folder of the server.

6. The medium of claim 5, including instructions to store the new metadata file created from manifests of the new OS instance at the root folder of the server.

7. The medium of claim 1, wherein the existing OS instance and the new OS instance are each hypervisor instances.

8. The medium of claim 1, wherein the boot modules associated with the new OS instance include tardisks.

9. The medium of claim 1, wherein the boot modules associated with the new OS instance include a root filesystem.

10. The medium of claim 1, wherein the boot modules associated with the new OS instance include an initial random access memory (RAM) disk (initrd).

11. The medium of claim 1, wherein the boot modules associated with the new OS instance include an initramfs.

12. The medium of claim 1, wherein the boot modules associated with the new OS instance include an installation module.

13. A method, comprising:
performing soft reboot prechecks on a computing device having a trusted platform module (TPM) and executing an existing operating system (OS) instance responsive to receiving a request to perform a soft reboot on the computing device;
loading a new kernel and boot modules associated with a new OS instance into a memory of the computing device;
measuring the boot modules into platform configuration registers (PCRs) of the TPM;
generating entries in an event log of the TPM corresponding to the boot modules and the new kernel;
exporting the event log and a metadata file associated with the existing OS instance to storage;
importing the event log from storage to the new kernel;
copying the metadata file from storage to a server; and
storing a new metadata file created from manifests of the new OS instance at the server.

14. The method of claim 13, wherein the method includes performing a remote attestation using the metadata file copied to the server.

15. The method of claim 13, wherein the method includes storing the event log in a Trusted Computing Group (TCG) format.

16. A system, comprising:
a request engine configured to receive a request to perform a soft reboot of a computing device executing an existing operating system (OS) instance and having a trusted platform module (TPM); and
a soft reboot engine configured to perform a soft reboot process on the computing device responsive to receiving the request, the soft reboot process comprising:
loading a new kernel and boot modules associated with a new OS instance into a memory of the computing device;
measuring the boot modules into platform configuration registers (PCRs) of the TPM;
generating entries in an event log of the TPM corresponding to the boot modules and the new kernel;
exporting the event log and a metadata file associated with the existing OS instance to storage;
importing the event log from storage to the new kernel;
copying the metadata file from storage to a server; and
storing a new metadata file created from manifests of the new OS instance at the server.

17. The system of claim 16, wherein the soft reboot engine is configured to measure, into the PCRs of the TPM:
the new kernel;
a version of the new kernel;
a signer certificate associated with the new kernel;
a command line associated with the new kernel; and
boot options associated with the new kernel.

18. The system of claim 16, wherein the boot modules associated with the new OS instance include tardisks.

19. The system of claim 16, wherein the boot modules associated with the new OS instance include a root filesystem.

20. The system of claim 16, wherein the boot modules associated with the new OS instance include an initial random access memory (RAM) disk.
